(19) United States
(12) Patent Application Publication
(10) Pub. No.: US 2001/0047333 A1
(43) Pub. Date: Nov. 29, 2001

(54) Method for billing a VoIP call in a communication system

(76) Inventors: Jung-Gi Kim, Suwon-shi (KR); Jeong-Sic Sung, Suwon-shi (KR)

Correspondence Address: Robert E. Bushnell, Suite 300, 1522 K Street, N.W., Washington, DC, 20005-1202, US

(21) Appl. No.: 09/825,888

(22) Filed: Apr. 5, 2001

(30) Foreign Application Priority Data
May 24, 2000 (KR) 2000/28159

(51) Int. Cl. G06F 17/60

(52) U.S. Cl. 705/40; 705/39

(57) ABSTRACT

A billing method starts billing a call at a time point where the called party answers the call. A extension subscriber connection processor of the calling party's VoIP gateway determines whether a called party responds to a call from the calling party, and upon receipt of the response, informs the VoIP trunk connection processor of receipt of the response. A VoIP trunk connection processor receives the response information from the called party at the extension subscriber connection processor, assembles a response packet, and transmits the assembled response packet to the calling party's VoIP gateway through a VoIP call channel. The calling party's VoIP gateway checks the response packet out of the packets received through the call channel, and transmits the checked response packet to the VoIP call processing central controller. The VoIP call processing central controller records a call start time for the corresponding VoIP call using the response information received from the VoIP trunk connection processor.

This application makes reference to, incorporates the same herein, and claims all benefits accruing under 35 U.S.C. §119 from my application METHOD AND SYSTEM FOR RADIO DATA COMMUNICATION IN COMMUNICATION SYSTEM filed with the Korean Industrial Property Office on May 24, 2000 and there duly assigned Ser. No. 2000/28159.

### BACKGROUND OF THE INVENTION

1. Field of the Invention

The present invention relates generally to amethod for billing a VoIP (Voice-over-Internet Protocol) call in a communication system, and in particular, to a VoIP call billing method for detecting an exact billing start time for a VoIP call originated from a VoIP gateway in the form of a private automatic branch exchange (PABX) through a VoIP trunk included in the PABX.

2. Description of the Related Art

Billing is started after transmission of asetup command according to Q.931 protocol and compatibility exchange occurs according to an H.245 compatibility procedure. In this method, however, it is not possible to exactly detect a time point where the called party actually starts the call by answering the call at the sound of the ringing tone. That is, the billing of a call starts when the ring tone is generated at the called party upon receiving the incoming VoIP call through the calling and called party's VoIP gateways. Therefore, calls are billed even when a receiver is never taken off the hook at the called party's phone. Although the called party has answered the call at the sound of the ringing tone, a call is billed when the ring tone is generated and before the called party answers the call.

### SUMMARY OF THE INVENTION

It is therefore an object of the present invention to provide an improved method for billing telephone calls using VoIP.

It is also an object to provide a fairer method for billing telephone calls using VoIP.

It is still yet another object of the present invention to provide a method for billing telephone calls using VoIP where the time billed starts only when the called party takes the receiver off the hook in response to ringing of the called party's telephone.

It is further an object to provide a method for telephone calls using the VoIP where there is no charge for ringing a called party's telephone if the called party fails to take the receiver off the hook.

It is yet another object of the present invention to provide a method for exactly detecting a VoIP call setup end time and an actual call start time between calling and called party's VoIP gateways, thereby to bill only the actual call time.

To achieve the above and other objects, there is provided a method for billing a VoIP call in a communication system in which a calling party's VoIP gateway is connected to a called party's VoIP gateway through an IP network, the calling and called party's VoIP gateways each including a VolP trunk connection processor, an extension subscriber connection processor and a VoIP call processing central controller. In the method the extension subscriber connection processor of the calling party's VoIP gateway determines whether acalled party responds to a call from the calling party, and upon receipt of the response, informs the VoIP trunk connection processor of receipt of the response. The VoIP trunk connection processor receives the response information from the called party at the extension subscriber connection processor, assembles a response packet, and transmits the assembled response packet to the calling party's VoIP gateway through a VoIP call channel. The calling party's VoIP gateway checks the response packet out of the packets received through the call channel, and transmits the checked response packet to the VoIP call processing central controller. The VoIP call processing central controller records a call start time for the corresponding VoIP call using the response information received from the VoIP trunk connection processor.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a network structure for processing a VoIP call;

FIG. 2 is a diagram illustrating a procedure for billing a VoIP call;

FIGS. 3A and 3B are diagrams illustrating a procedure for billing a VoIP call in a calling party according to an embodiment of the present invention; and

FIG. 4 is a diagram illustrating a procedure for billing the VoIP call in a called party according to an embodiment of the present invention.

### DETAILED DESCRIPTION OF THE INVENTION

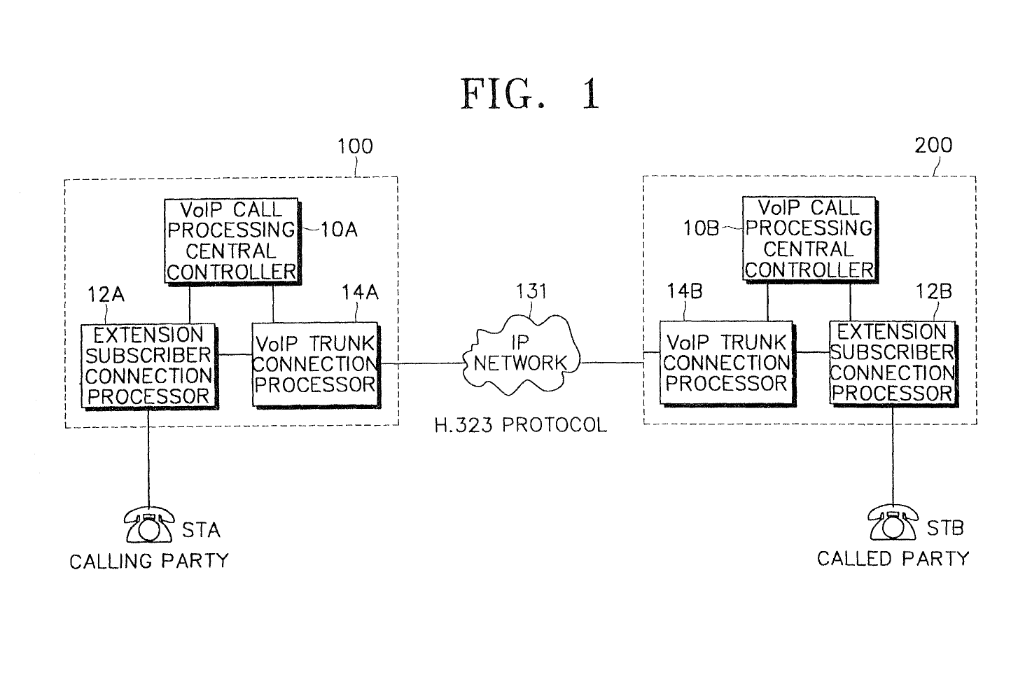

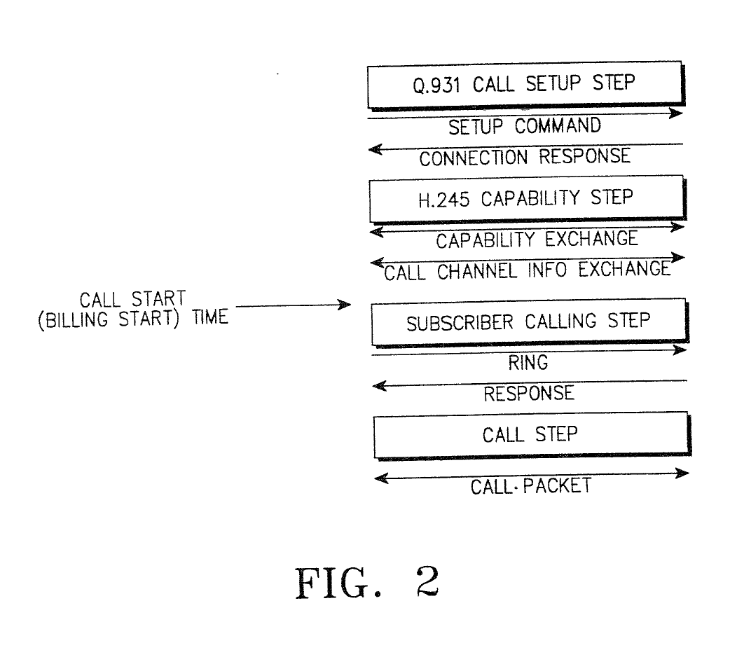

FIG. 1 illustrates a network structure in which a calling party's VoIP gateway 100 is connected to a called party's VoIP gateway 200 via an Internet protocol (IP) network 131. As illustrated, the calling party's VoIP gateway 100 and the called party's gateway 200 each are in the form of PABX and include a VoIP trunk connection processor 14, an extension subscriber connection processor 12 and a VoIP call processing central controller 10. Generally, signal transmission between the calling and called party's VoIP gateways 100 and 200 is performed according to an H.323 VoIP protocol of the IP network 131, as shown in FIGS. 1 and 2. For VoIP communication, an actual VoIP call is performed after a VoIP call procedure and a capability exchange procedure between the calling and called party's VoIP gateways 100 and 200. Referring to FIG. 2, in order to make a VoIP call, the calling party's VoIP gateway 100 transmits a setup command to the called party's VoIP gateway 200 via the IP network 131 according to a Q.931 call setup protocol, and then, the called party's VoIP gateway 200 transmits a connection response (or approval) signal to the calling party's VoIP gateway 100. Subsequently, an H.245 capability procedure is performed by mutually exchanging capability and call channel information. Thereafter, as call billing is started, a subscriber calling step is performed. In the subscriber calling step, the calling party's VoIP gateway 100 transmits a ring signal and then, the called party's VoIP gateway 200 transmits a response thereto, entering a call step. In the call step, a call packet is exchanged between the calling and called party's VoIP gateways 100 and 200.

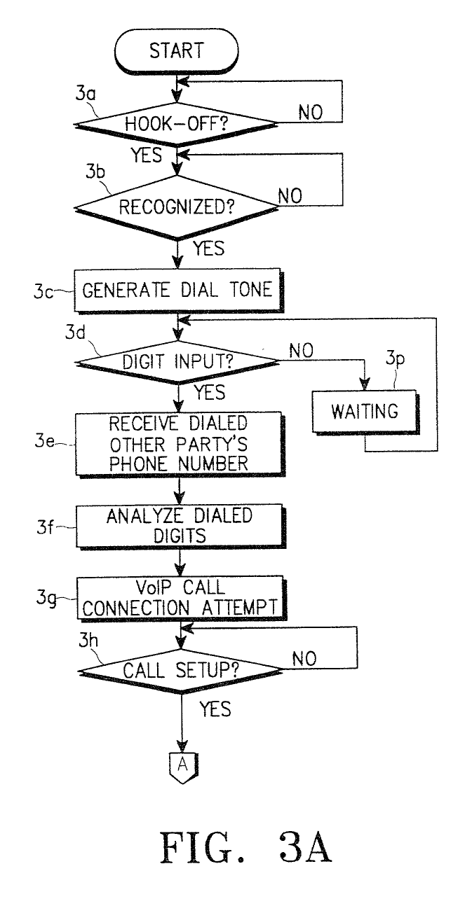

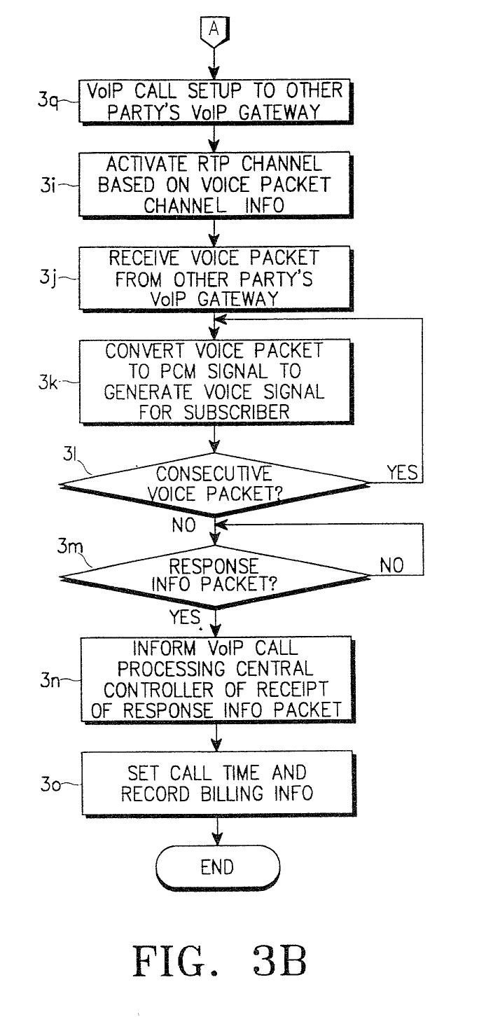

FIGS. 3A and 3B illustrate a procedure for billing a VoIP call in the calling party according to an embodiment of the present invention. The procedure includes the steps of: (a) generating a dial tone when a VoIP call processing central controller detects hook-off, and waiting for digits to be input; (b) analyzing the dialed digits corresponding to a phone number of the other party (i.e., called party), and attempting to connect a VoIP call to determine whether the call is setup or not; (c) performing VoIP call setup to the other party's VoIP gateway, when the call is setup in step (b); (d) receiving a voice packet from the other party by activating a voice packet channel, after performing the VoIP call setup; (e) converting the received voice packet to a PCM (Pulse Code Modulation) signal for the subscriber and determining whether there exists a consecutive voice packet being received; and (f) determining, when there is no consecutive voice packet, whether a response information packet is received or not, and informing, when the response information packet is received, receipt ofthe response information packet to the VoIP call processing central controller, setting a call time, and recording billing information.

A detailed description ofthe embodiment will be made below with reference to FIGS. 3A and 3B. When a subscriber STA of the calling party's VoIP gateway 100 picks up the handset, the extension subscriber connection processor 12A detects hook-off and informs the VoIP call processing central controller 10A of detection of the hook-off, in step 3a. Upon recognizing the hook-off in step 3b, the VoIP call processing central controller 10A generates a dial tone for the subscriber according to the digits dialed to call the other party, using the extension subscriber connection processor 12A, in step 3c. The VoIP call processing central controller 10A determines in step 3d whether there are input digits. When there are no input digits, the VoIP call processing central controller 10A awaits dialed digits being input in step 3p. Otherwise, when there are input digits, the extension subscriber connection processor 12A receives the other party's phone number of the digits dialed by the subscriber and transmits the received phone number to the VoIP call processing central controller 10A in step 3e. The VoIP call processing central controller 10A analyzes the dialed digits consulting a database in step 3f, to find out an Internet protocol of the other party's VoIP gateway 200. Thereafter, in step 3g, the VoIP call processing central controller 10A commands the VoIP trunk connection processor 14A to connect a VoIP call. When a call is setup through the call setup attempt in step 3h, the VoIP trunk connection processor 14A performs VoIP call setup to the other party's VoIP gateway 200 according Q.931 and H.245 protocols in step 3q. Next, the VoIP trunk connection processor 14A activates a voice packet or ring-back tone packet (RTP) channel depending on voice packet channel information exchanged during the call setup in step 3i, receives a voice packet (or ring-back tone) transmitted from the other party's VoIP gateway 200 through the activated voice packet channel in step 3j, and converts the received voice packet to a PCM signal for the subscriber in step 3k. If there is a consecutive voice packet being received in step 31, the step 3k is repeated. Otherwise, if there is no consecutive voice packet, the VoIP trunk connection processor 14A analyzes the RTP packet to determine whether it is a response information packet, in step 3m. If it is the response information packet, the VoIP trunk connection processor 14A informs the VoIP call processing central controller 10A of receipt of the response information packet in step 3n, i.e., informs that the called party has answered the call by picking up the handset, and the VoIP call processing central controller 10A sets a call start time and records billing information in step 3o.

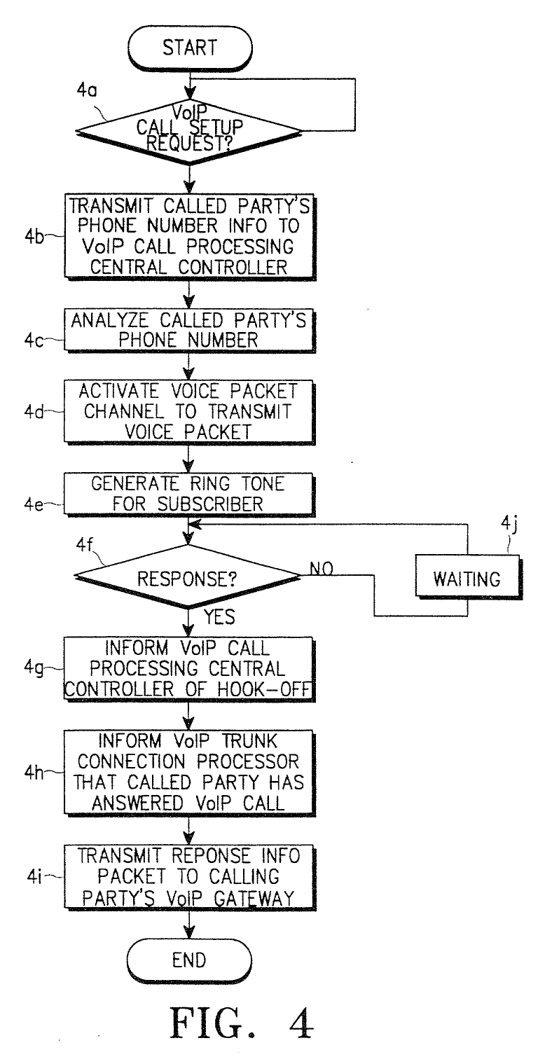

FIG. 4 illustrates a procedure for billing a VoIP call in the called party according to an embodiment of the present invention. The procedure includes the steps of: (a) upon receipt of a VoIP call setup request from the calling party, transmitting a called party's phone number to the VoIP call processing central controller to analyze the called party's phone number; (b) activating a voice packet channel according to the analyzing results to transmit a voice packet, generating a ring tone for the extension subscriber, and determining whether a response is received from the calling party; and (c) upon failure to receive a response, awaiting the response, and upon receipt of a response, informing the VoIP call processing central controller and the VoIP trunk connection processor of receipt of the response, and then transmitting a response information packet for the corresponding call to the calling party's VoIP gateway.

A detailed description of the embodiment will be made below with reference to FIG. 4. The VoIP trunk connection processor 14B determines in step 4a whether there exists a call setup request from the other party's (i.e., calling party's) VoIP gateway 100. When there exists a call setup request, the VoIP trunk connection processor 14B receives the VoIP call setup request and informs the VoIP call processing controller 10B of the requested called party's phone number information in step 4b. Thereafter, the VoIP call processing central controller 10B analyzes the called party's phone number in step 4c, and commands the VoIP trunk connection processor 14B to activate the RTP channel to transmit a voice packet (or ring-back tone) through the RTP channel in step 4d. The VoIP call processing central controller 10B commands the extension sub scriber connection processor 12B to generate a ring tone for the subscriber in step 4e, and awaits a response from the subscriber in step 4f. When the subscriber responds by picking up the handset, the extension subscriber connection processor 12B detects hook-off and informs the VoIP call processing central controller 10B of the hook-off in step 4g. The VoIP call processing central controller 10B informs the VoIP trunk connection processor 14B that the called party has answered the VoIP call, in step 4h. The VoIP trunk connection processor 14B assembles a response information packet for the corresponding call and transmits the assembled response information packet to the calling party's VoIP gateway 100 through the activated RTP channel in step 4i.

As described above, when a VoIP call is performed through a VoIP gateway, the novel method can exactly detect an actual call start point where the called party picks up the handset through the call setup step and the capability exchange step. Therefore, the novel method can exactly bill only the actual call time, when the VoIP call is made. Further, when the called party does not answer the connected VoIP call even at the sound of the ringing tone, the novel method will not bill the call. Accordingly, it is possible to increase reliability of the billing system.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for billing a VoIP (Voice-over-Internet Protocol) call in a communication system in which, the method comprising the steps of:
providing a calling party's VoIP gateway is connected to a called party's VoIP gateway through an IP network, the calling and called party's VoIP gateways each including a VoIP trunk connection processor, an extension subscriber connection processor and a VoIP call processing central controller;
determining, in the extension subscriber connection processor of the calling party's VoIP gateway, whether a called party responds to a call from the calling party, and upon receipt of the response, informing the VoIP trunk connection processor of receipt of the response;
receiving, in the VoIP trunk connection processor, the response information from the called party at the extension subscriber connection processor, assembling a response packet, and transmitting the assembled response packet to the calling party's VoIP gateway through a VoIP call channel;
checking, in the calling party's VoIP gateway, the response packet out of the packets received through the call channel, and transmitting the checked response packet to the VoIP call processing central controller; and
recording, in the VoIP call processing central controller, a call start time for the corresponding VoIP call using the response information received from the VoIP trunk connection processor.

2. A VoIP call billing method, the method comprising the steps of:
(a) providing a calling party in a communication system in which a calling party's VoIP gateway is connected to a called party's VoIP gateway through an IP network, the calling and called party's VoIP gateways each including a VoIPtrunk connection processor, an extension subscriber connection processor and a VoIP call processing central controller;
(b) generating a dial tone when a VoIP call processing central controller detects hook-off, and waiting for digits to be input;
(c) analyzing the dialed digits corresponding to a phone number of the other party, and attempting to connect a VoIP call to determine whether the call is setup or not;
(d) performing VoIP call setup to the other party's VoIP gateway, when the call is setup in step (c);
(e) receiving a voice packet from the other party by activating a voice packet channel, after performing the VoIP call setup;
(f) converting the received voice packet to a PCM (Pulse Code Modulation) signal for the subscriber and determining whether there exists a consecutive voice packet being received; and
(g) determining, when there is no consecutive voice packet, whether a response information packet is received or not, and informing, when the response information packet is received, receipt of the response information packet to the VoIP call processing central controller, setting a call time, and recording billing information.

3. A VoIP call billing method, the method comprising the steps of:
(a) providing a called party in a communication system in which a calling party's VoIP gateway is connected to a called party's VoIP gateway through an IP network, the calling and called party's VoIP gateways each including a VoIP trunk connection processor, an extension subscriber connection processor and a VoIP call processing central controller;
(b) upon receipt of a VoIP call setup request from the calling party, transmitting a called party's phone number to the VoIP call processing central controller to analyze the called party's phone number;
(c) activating a voice packet channel according to the analyzing results to transmit a voice packet, generating a ring tone for the extension subscriber, and determining whether a response is received from the calling party; and
(d) upon failure to receive a response, awaiting the response, and upon receipt of a response, informing the VoIP call processing central controller and the VoIP trunk connection processor of receipt of the response, and then transmitting a response information packet for the corresponding call to the calling party's VoIP gateway.

4. A method for billing a voice over the internet (VoIP) call, said method comprising the steps of:
(a) picking up the handset of the calling party's telephone;
(b) detecting an off hook condition in an extension subscriber connection processor of a calling party's gateway;
(c) informing a VoIP call processing central controller ofthe calling party's gateway that the calling party's telephone is off the hook;
(d) generating a dial tone for the calling party by said VoIP call processing central controller;
(e) inputting digits identifying a called party into said calling party's telephone handset;
(f) recognizing said input digits by said VoIP call processing central controller;
(g) transmitting the inputted digits from said extension subscriber connection processor to said VoIP call processing central controller;
(h) analyzing the input digits to determine an Internet protocol of the called party's gateway;
(i) connecting the call between the calling party's gateway and the called party's gateway by having the calling party's VoIP call processing central controller command the VoIP trunk connection processor;
(j) activating a packet by the VoIP trunk connection processor of the calling party's gateway;
(k) receiving a packet from called party's gateway;
(l) converting said packet to pulse controlled modulation signal to generate voice signal for the caller;
(m) analyzing said packet by said caller's VoIP trunk connection processor to determine whether it is a response information packet;
(n) informing said VoIP call processing central controller by said VoIP trunk connection processor of receipt of the response information packet; and
(o) setting a call start time and recording biloing by said VoIP call processing central controller of said calling party's gateway.

5. The method of claim 4, where said packet in steps (j) through (m) are voice packets.

6. The method of claim 4, wherein said packet in steps (j) through (m) are ring-back tone packets.

7. The method of claim 4, wherein said call is originated from a VoIP gateway in the form of a private automatic branch exchange.

8. A method for billing a voice over the internet (VoIP) call, said method comprising the steps of:
(a) receiving, through a VoIP trunk connection processor of the called party's gateway a call setup request from the calling party's gateway;
(b) transmitting called party's phone number information to a VoIP call processing central controller in said called party's gateway;
(c) analyzing the called party's phone number by said VoIP call processing central controller;
(d) activating a ring-back tone packet channel to transmit a packet through said ring-back tone packet channel by said VoIP trunk connection processor of the called party's gateway;
(e) generating a ring tone for a subscriber on a phone of said called party's gateway via said VoIP call processing central controller and said extension subscriber connection processor of said called party's gateway;
(f) picking up the phone off the hook on the called party's telephone;
(g) detecting the off-hook condition by said extension subscriber connection processor of said called party's gateway;
(h) informing the VoIP call processing central controller of the off-hook condition;
(i) informing the VoIP trunk connection processor of the called party's gateway of the offhook condition;
(j) assembling a response information packet by the VoIP trunk connection processor of the called party's gateway; and
(k) transmitting said response information packet to a calling party's gateway.

9. The method of claim 8, wherein the packet of step (d) is a voice packet.

10. The method of claim 8, wherein the packet of step (d) is a ring-back tone packet.

11. The method of claim 8, wherein said call is originated from a VoIP gateway in the form of a private automatic branch exchange.
